(19) United States
(12) Patent Application Publication
(10) Pub. No.: US 2026/0288385 A1
(43) Pub. Date: Sep. 24, 2026

(54) IMAGE PROCESSING APPARATUS, IMAGE PROCESSING SYSTEM, NON-TRANSITORY COMPUTER READABLE MEDIUM, AND METHOD

(71) Applicant: FUJIFILM Business Innovation Corp., Tokyo (JP)

(72) Inventors: Natsuko Kato, Kanagawa (JP); Risa Hayashi, Kanagawa (JP); Yuki Kanazawa, Kanagawa (JP); Ryosuke Masuko, Kanagawa (JP); Naoto Ikeda, Kanagawa (JP); Masanori Satake, Kanagawa (JP)

(73) Assignee: FUJIFILM Business Innovation Corp., Tokyo (JP)

(21) Appl. No.: 19/309,080

(22) Filed: Aug. 25, 2025

(30) Foreign Application Priority Data
Mar. 19, 2025 (JP) 2025-044379

(51) Int. Cl. G06F 3/12

(52) U.S. Cl. CPC G06F 3/1219; G06F 3/1205; G06F 3/1253; G06F 3/1285

(57) ABSTRACT

An image processing apparatus includes a processor configured to: generate a change suggestion in a print setting in accordance with a situation of the print setting; and display a button for displaying the generated change suggestion, on a setting screen for setting the print setting.

### CROSS-REFERENCE TO RELATED APPLICATIONS

This application is based on and claims priority under 35 USC 119 from Japanese Patent Application No. 2025-044379 filed Mar. 19, 2025.

### BACKGROUND

### (i) Technical Field

The present disclosure relates to an image processing apparatus, an image processing system, a non-transitory computer readable medium, and a method.

### (ii) Related Art

On a setting screen for setting a print process of a printer, multiple setting items are displayed in a list. A user selects, for parameter setting, a setting item, which is to be changed, from the list of setting items. However, some users do not know how the parameter of a setting item in the list is to be set, and, in the first place, some users do not know what functions are provided for the printer. Therefore, there is a known technique of displaying guidance on setting items (for example, Japanese Unexamined Patent Application Publication No. 2018-97617).

However, only with a description about the functions of the respective setting items, it may be difficult for a user to determine whether the settings are in line with the current situation or whether the settings are in line with the user's intention.

### SUMMARY

Aspects of non-limiting embodiments of the present disclosure relate to a technique allowing print setting which is in line with the situation in printing or a user's intention, compared with the case in which only a description about the functions of the respective setting items is provided as guidance.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus comprising: a processor configured to: generate a change suggestion in a print setting in accordance with a situation of the print setting; and display a button for displaying the generated change suggestion, on a setting screen for setting the print setting.

### BRIEF DESCRIPTION OF THE DRAWINGS

Exemplary embodiment of the present disclosure will be described in detail based on the following figures, wherein:

FIG. 1 is a diagram illustrating an exemplary entire configuration of an image processing system to which the present exemplary embodiment is applied;

FIG. 2 is a diagram illustrating an exemplary hardware configuration of an image processing apparatus to which the present exemplary embodiment is applied;

FIG. 3 is a diagram illustrating an exemplary functional configuration of a controller of an image processing apparatus;

FIG. 4 is a flowchart of an exemplary process until a change suggestion in print settings is generated, among the processes of an image processing apparatus;

FIG. 5 is a flowchart of an exemplary process of generating a change suggestion in print settings, among the processes of an image processing apparatus;

FIG. 6 is a diagram illustrating a concrete example of a setting screen displaying a suggestion button;

FIG. 7 is a diagram illustrating a concrete example of a suggestion screen displayed by pressing a suggestion button;

FIG. 8 is a diagram illustrating another concrete example of a setting change button displayed on a suggestion screen;

FIG. 9 is a diagram illustrating a concrete example of setting items which are suggested t be changed and which are displayed in a list by pressing a setting change button;

FIG. 10 is a diagram illustrating a concrete example of a setting screen displaying multiple suggestion buttons; and

FIG. 11 is a diagram illustrating a concrete example of a suggestion screen displaying, as a list, a change suggestion of print settings of a type corresponding to a pressed suggestion button.

### DETAILED DESCRIPTION

Referring to the attached drawings, an exemplary embodiment of the present disclosure will be described in detail below.

### Configuration of Image Processing System 1

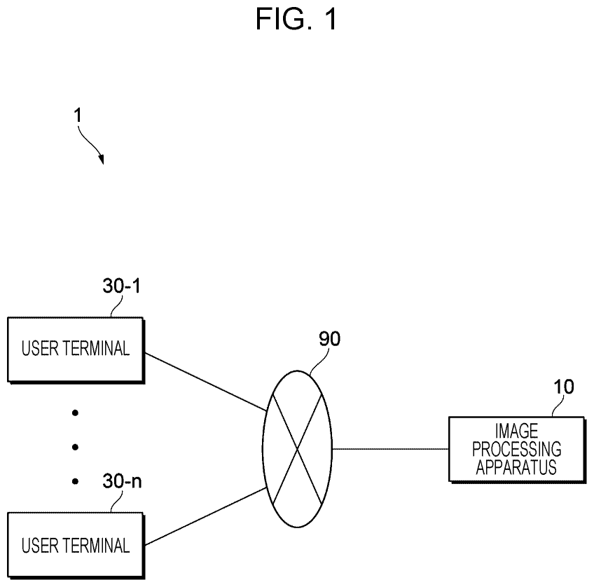

FIG. 1 is a diagram illustrating an exemplary entire configuration of an image processing system 1 to which the present exemplary embodiment is applied. The image processing system 1 enables print settings in line with the situation in printing or a user's intention. The image processing system 1 includes an image processing apparatus 10 and user terminals 30-1 to 30-n (n is an integer more than or equal to one) which are connected over a network 90. Examples of the network 90 include a local area network (LAN) and the Internet. Hereinafter, when the user terminals 30-1 to 30-n are not necessarily described individually, these are collectively called user terminals 30.

### Image Processing Apparatus 10

The image processing apparatus 10 performs various processes in accordance with input operations performed by users who use the image processing system 1. For example, the image processing apparatus 10 is capable of performing a print process of forming, for output, an image on a sheet or the like as a recording medium, a copy process of copying, for output, a document image onto a sheet or the like, a reading process of reading an image formed on a sheet or the like, and a process of transmitting a document by facsimile. The image processing apparatus 10 may be, for example, a multifunction device of a so-called electrophotographic system which forms a toner image on a print surface of a sheet, or a printer of a so-called inkjet system which ejects ink on a print surface of a sheet.

The image processing apparatus 10 displays a user interface, receives input operations on the user interface, and obtains the input information. The input operations on the user interface are classified into direct operation or remote operation. The direct operation refers to a direct input operation performed by a user, who is in front of the image processing apparatus 10, on the user interface displayed on the image processing apparatus 10. The remote operation refers to an indirect input operation performed by a user, who operates a user terminal 30 connected to the image processing apparatus 10 over the network 90, on a user interface displayed on the user terminal 30.

The image processing apparatus 10 is capable of obtaining, for execution of various processes, various types of information transmitted from the user terminals 30 and the outside. The image processing apparatus 10 is capable of transmitting various types of information to the user terminals 30 and the outside. For example, the image processing apparatus 10 generates a change suggestion in print settings in accordance with the situation of print settings. The expression, “the situation of print settings”, refers to, for example, the situation of setting of print parameters. The expression, “generate a change suggestion in print settings” , refers to, for example, generating a screen (hereinafter called a “suggestion screen”) including a change suggestion in print settings.

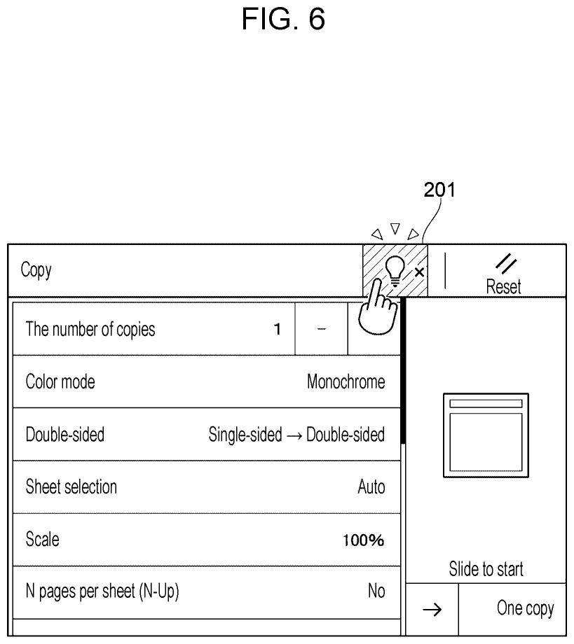

The image processing apparatus 10 displays, on a setting screen for setting printing, a button (hereinafter called a “suggestion button”) for displaying a generated suggestion screen. The display form of the suggestion button is not particularly limited. The display form of a suggestion button on a setting screen for setting printing will be described by referring to concrete examples in FIG. 6 and its subsequent figures.

In addition, the image processing apparatus 10 is capable of generating a change suggestion in print settings in accordance with information (hereinafter called “document information”) about a document to be printed, and the situation of print settings. The document information may include, for example, information, such as the number of pages, monochrome/color, and the file size. The image processing apparatus 10 may generate a change suggestion in print settings in accordance with the number of pages obtained from the document information and the situation of print settings. When the number of pages obtained from the document information exceeds a predetermined value, the image processing apparatus 10 may generate a change suggestion in print settings for suppressing the number of printed sheets. In this case, for example, a suggestion that single-sided printing is changed to double-sided printing and that 1UP (printing one page per sheet) is changed to 2UP (printing two pages per sheet) is made.

The image processing apparatus 10 is capable of generating a change suggestion in print settings in accordance with information (hereinafter called “user information”) about a user who operates a setting screen and the situation of print settings. The user information may include, for example, information with which a user may be uniquely identified, a limitation on the number of sheets which are allowed to be used (for example, within ten sheets), a limitation on ink color which is allowed to be used (for example, only black and white), and information about whether a login has been performed. The image processing apparatus 10 is capable of generating a change suggestion in print settings in accordance with information about a user's limitations in printing, which is obtained from the user information, and the situation of print settings.

Specifically, the image processing apparatus 10 is capable of generating a change suggestion in print settings in accordance with the situation of print settings and information which describes the limitation on the number of sheets a user is allowed to use in printing and which serves as information about the user's limitation in printing. In addition, the image processing apparatus 10 is capable of generating a change suggestion in print settings in accordance with the situation of print settings and information which describes a limitation on color a user is allowed to use in printing and which serves as information about the user's limitation in printing. Further, the image processing apparatus 10 is capable of generating a change suggestion in print settings in accordance with information about the limitation on the number of sheets which a user is allowed to use in printing, information about the limitation on color which the user is allowed to use in printing, and the situation of print settings.

The image processing apparatus 10 is capable of generating a change suggestion in print settings in accordance with information (hereinafter called “printer information”) about the image processing apparatus 10 which performs a print process and the situation of print settings. The printer information may include, for example, information with which the image processing apparatus 10 may be uniquely identified, information about the performance of the image processing apparatus 10, and information about the remaining number of sheets which are set in a paper feed tray. In this case, image processing apparatus 10 is capable of generating a change suggestion in print settings in accordance with information about the image processing apparatus 10's limitations in printing, which is obtained from the printer information, and the situation of print settings. Specifically, the image processing apparatus 10 is capable of generating a change suggestion in print settings in accordance with the situation of print settings and the remaining amount of material used in a print process, which serves as information about the image processing apparatus 10's limitation in printing. The expression, “material used in a print process”, refers to, for example, sheets, toner, and an ink cartridge.

The image processing apparatus 10 is capable of generating a change suggestion in print settings in accordance with at least two types of information among the document information, the user information, and the printer information, and the situation of print settings.

The image processing apparatus 10 displays, on a suggestion screen, a predetermined button (hereinafter called a “setting change button”), serving as a button for changing print settings, as well as a change suggestion in print settings. When the setting change button is pressed, a screen for changing print settings may be displayed, or setting items suggested to be changed may be displayed in a list. When the setting change button is pressed, print settings may be changed immediately. The details of the configuration and processes of the image processing apparatus 10 will be described below.

### User Terminals 30

The user terminals 30 are information processing apparatuses, such as smartphones, tablet terminals, and personal computers, which are operated by users who use the image processing system 1. In the user terminals 30, application software, which enables the image processing apparatus 10 to be remotely operated, is installed. The user terminals 30 are capable of displaying an interface which enables remote operations on the image processing apparatus 10. The user terminals 30 are capable of obtaining, for execution of various processes, various types of information transmitted from the image processing apparatus 10 and the outside. The user terminals 30 are capable of transmitting various types of information to the image processing apparatus 10 and the outside.

For example, the user terminals 30 transmit, to the image processing apparatus 10, information, such as instructions to change print settings and instructions to do jobs, on the basis of information which is input on the user interface. The user interface displayed on the user terminals 30 may display substantially the same information as that on the user interface displayed on the image processing apparatus 10. That is, the setting screen, the suggestion button, the suggestion screen, the setting change button, and the like which are described above may be displayed. The details of the configuration and processes of the user terminals 30 will be described below.

The configuration of the image processing system 1 is an example. Any configuration may be employed as long as the image processing system 1, as a whole, is provided with functions for implementing the processes. Therefore, among the functions for implementing the above-described processes, some or all may be shared in the image processing system 1, or may be performed in cooperation. For example, some or all of the functions of the image processing apparatus 10 included in the image processing system 1 may be performed as functions of another information processing apparatus (for example, the user terminals 30); some or all of the functions of another information processing apparatus may be performed as functions of the image processing apparatus 10. Further, some or all of the functions of the image processing apparatus 10 and other apparatuses included in the image processing system 1 may be transferred to another server or the like (not illustrated). Thus, functions of the image processing system 1, as a whole, may be promoted. In addition, processes may be complemented to one another.

### Hardware Configuration

### Hardware Configuration of Image Processing Apparatus 10

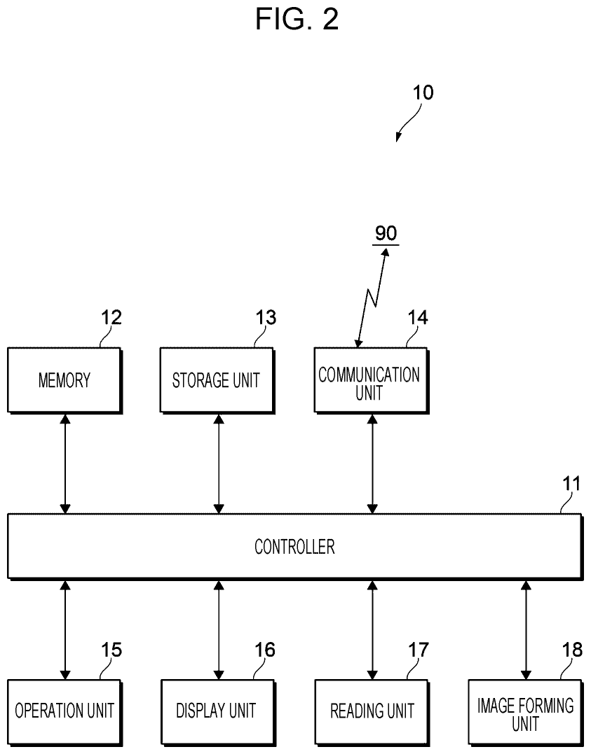

FIG. 2 is a diagram illustrating an exemplary hardware configuration of the image processing apparatus 10 to which the present exemplary embodiment is applied.

The image processing apparatus 10 includes a controller 11, a memory 12, a storage unit 13, a communication unit 14, an operation unit 15, a display unit 16, a reading unit 17, and an image forming unit 18. These units are connected to each other, for example, through a data bus, an address bus, or a peripheral component interconnect (PCI) bus.

The controller 11 is a processor which controls functions of the image processing apparatus 10 through execution of various types of software, such as basic software (OS) and application software. In the present exemplary embodiment, the processes are performed by any computer. The computer may perform the processes by using a processor serving as hardware, a program serving as software, or combination of these. In this case, the processor is configured to perform the processes in the exemplary embodiment in cooperation with the program and may function as a unit or a means in the exemplary embodiment. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other.

The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The memory 12, which is a storage area for storage of various types of software and data or the like used in execution of the software, is used as a work area in computation. The memory 12 is formed, for example, of a random access memory (RAM).

The storage unit 13 is a storage area for storage of input data for various types of software, output data from various types of software, and the like. The storage unit 13 is formed, for example, of a hard disk drive (HDD), a solid state drive (SSD), and a semiconductor memory which are used in storage of programs, various types of setting data, and the like. The storage unit 13 includes a database storing various types of information.

The communication unit 14 receives/transmits data from/to the user terminals 30 and the outside over the network 90. The operation unit 15, which is formed, for example, of a keyboard, a mouse, mechanical buttons, and switches, receives input operations.

The operation unit 15 includes a touch sensor forming a touch panel integrally with the display unit 16.

The display unit 16, which is formed, for example, of a liquid-crystal display or an organic light-emitting diode (OLED) display used in display of information, displays image data, text data, and the like. The display unit 16 displays a user interface or the like.

The reading unit 17 reads an image recorded on a medium such as a sheet. The reading unit 17 may be formed, for example, of a charge coupled device (CCD) scanner which reduces, through a lens, reflected light for light emitted onto a document from a light source and which receives the reduced light by CCDs. The reading unit 17 may be formed, for example, of a contact image sensor (CIS) scanner which receives, by a CIS, reflected light for light emitted sequentially onto a document from a light-emitting diode (LED) light source. The image forming unit 18 forms an image, which is to be printed, on a print surface of a sheet serving as a recording medium, for example, by using an electrophotographic system or an inkjet system.

### Hardware Configuration of User Terminal 30

A user terminal 30 includes a controller, a memory, a storage unit, a communication unit, an operation unit, and a display unit which correspond to the controller 11, the memory 12, the storage unit 13, the communication unit 14, the operation unit 15, and the display unit 16, respectively, in FIG. 2.

### Functional Configuration of Image Processing Apparatus 10

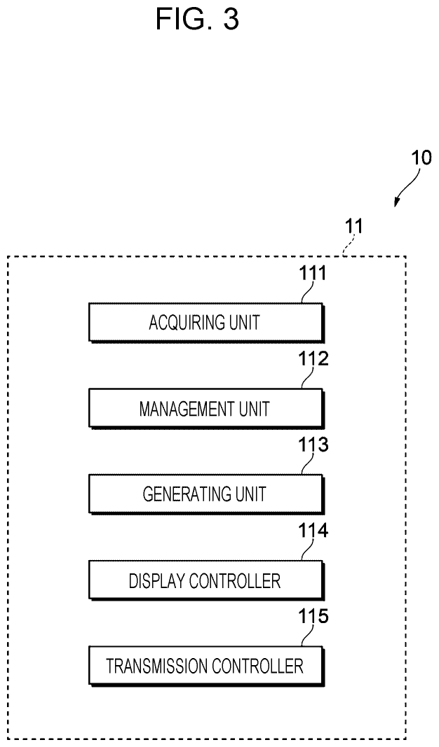

FIG. 3 is a diagram illustrating an exemplary functional configuration of the controller 11 of the image processing apparatus 10.

The controller 11 of the image processing apparatus 10 functions as an acquiring unit 111, a management unit 112, a generating unit 113, a display controller 114, and a transmission controller 115.

The acquiring unit 111 acquires various types of information. For example, the acquiring unit 111 acquires information (hereinafter called “setting information”) about the situation of print settings, which is transmitted from the user terminals 30. The acquiring unit 111 acquires the document information transmitted from the user terminals 30. The acquiring unit 111 acquires the user information transmitted from the user terminals 30. The acquiring unit 111 acquires the printer information transmitted from the user terminals 30.

The management unit 112 stores, for management, various types of information in the database of the storage unit 13 (see FIG. 2). For example, the management unit 112 stores, for management, the setting information, which is acquired by the acquiring unit 111, in the database. The management unit 112 stores, for management, the user information, which is acquired by the acquiring unit 111, in the database. The management unit 112 stores, for management, the printer information, which is acquired by the acquiring unit 111, in the database.

The generating unit 113 generates various types of information on the basis of various types of information. For example, the generating unit 113 generates a change suggestion in print settings in accordance with the situation of print settings which is specified from the acquired setting information. For example, the generating unit 113 is capable of generating a change suggestion in print settings in accordance with the document information and the situation of print settings. The generating unit 113 is capable of generating a change suggestion in print settings in accordance with the user information and the situation of print settings. The generating unit 113 is capable of generating a change suggestion in print settings in accordance with the printer information and the situation of print settings. The generating unit 113 is capable of generating a change suggestion in print settings in accordance with at least two types of information among the document information, the user information, and the printer information, and the situation of print settings. The generating unit 113 generates a suggestion screen including a change suggestion in print settings.

The display controller 114 exerts control for causing the display unit 16 (see FIG. 2) and the display units of the user terminals 30 to display a setting screen which allows print setting. The display controller 114 exerts control for displaying a suggestion button in a predetermined area on the setting screen. In response to pressing the suggestion button, the display controller 114 exerts control for displaying a suggestion screen. The display controller 114 exerts control for displaying a setting change button on the suggestion screen.

The transmission controller 115 exerts control for transmitting various types of information through the communication unit 14 (see FIG. 2). For example, the transmission controller 115 exerts control for transmitting various types of information to the user terminals 30 and the outside.

### Process Flow of Image Processing Apparatus 10

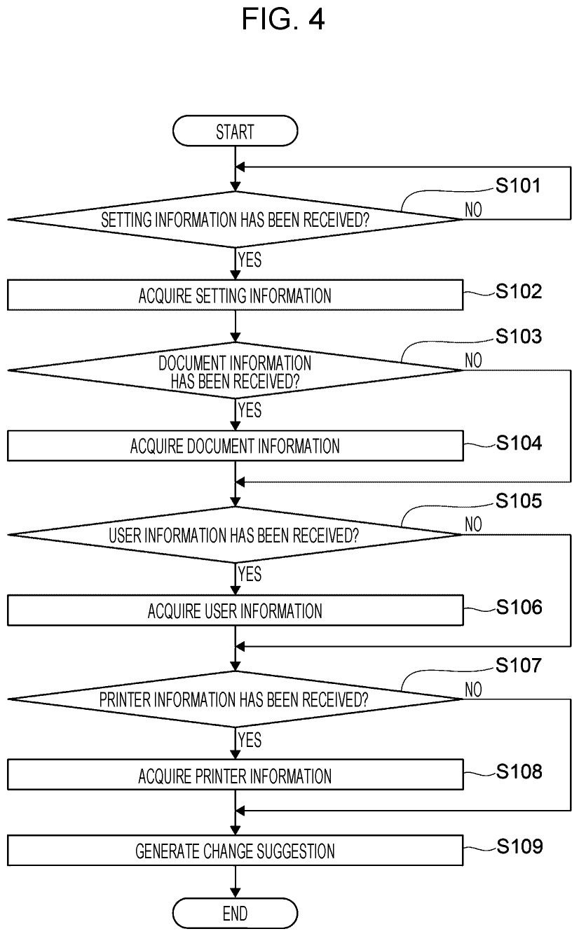

FIG. 4 is a flowchart of an exemplary process until a change suggestion in print settings is generated, among the processes of the image processing apparatus 10.

If the setting information has been received (YES in step 101), the image processing apparatus 10 acquires the received setting information (step 102), and stores it in the database of the storage unit 13 (see FIG. 2). Then, the image processing apparatus 10 proceeds to the determination process in step 103. In contrast, if the setting information has not been received (NO in step 101), the image processing apparatus 10 repeatedly performs the determination process in step 101.

If the document information has been received (YES in step 103), the image processing apparatus 10 acquires the received document information (step 104), and stores it in the database of the storage unit 13. Then, the image processing apparatus 10 proceeds to the determination process in step 105. In contrast, if the document information has not been received (NO in step 103), the image processing apparatus 10 proceeds to the determination process in step 105.

If the user information has been received (YES in step 105), the image processing apparatus 10 acquires the received user information (step 106), and stores it in the database of the storage unit 13. Then, the image processing apparatus 10 proceeds to the determination process in step 107. In contrast, if the user information has not been received (NO in step 105), the image processing apparatus 10 proceeds to the determination process in step 107.

If the printer information has been received (YES in step 107), the image processing apparatus 10 acquires the received printer information (step 108), and stores it in the database of the storage unit 13. Then, the image processing apparatus 10 proceeds to the process in step 109. In contrast, if the printer information has not been received (NO in step 107), the image processing apparatus 10 proceeds to the process in step 109. The image processing apparatus 10 generates a change suggestion (step 109), and ends the process (END).

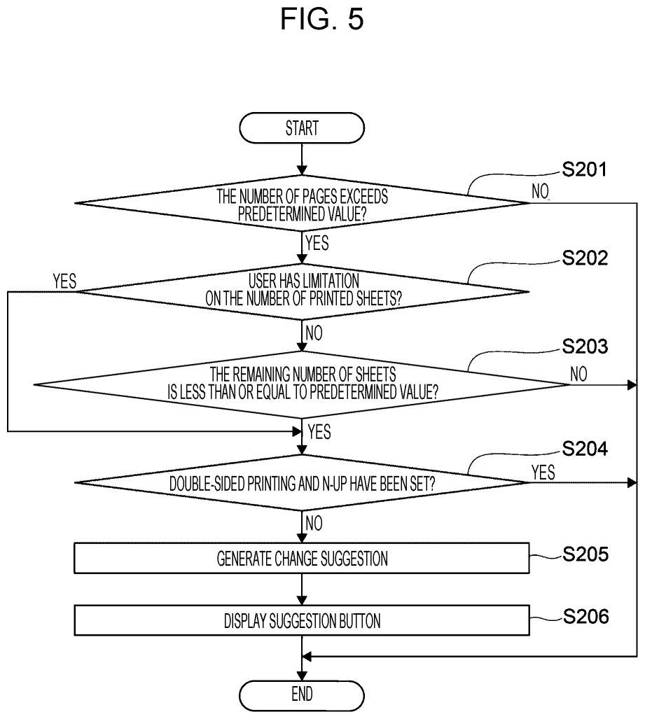

FIG. 5 is a flowchart of an exemplary process of generating a change suggestion in print settings, among the processes of the image processing apparatus 10. The example in FIG. 5 illustrates a process flow for generating a change suggestion, which is related to the number of sheets, of print settings.

If the number of pages which is determined from the document information exceeds a predetermined value (YES in step 201), the image processing apparatus 10 proceeds to the determination process in step 202. In contrast, if the number of pages which is determined from the document information does not exceed the predetermined value (NO in step 201), the image processing apparatus 10 ends the process of generating a change suggestion in print settings (END).

If the user has a limitation on the number of printed sheets (YES in step 202), the image processing apparatus 10 proceeds to the determination process in step 204. Whether the user has a limitation on the number of printed sheets is determined from the user information. In contrast, if the user has no limitation on the number of printed sheets (NO in step 202), the image processing apparatus 10 proceeds to the determination process in step 203.

If the remaining number of sheets, which is determined from the printer information, is less than or equal to a predetermined value (YES in step 203), the image processing apparatus 10 proceeds to the determination process in step 204. In contrast, if the remaining number of sheets, which is determined by the printer information, exceeds the predetermined value (NO in step 203), the image processing apparatus 10 ends the process of generating a change suggestion in print settings (END).

If double-sided printing and N-Up among the print settings have not been set (NO in step 204), the image processing apparatus 10 proceeds to the process in step 205. In contrast, if double-sided printing and N-Up among the print settings have been set (YES in step 204), the image processing apparatus 10 ends the process of generating a change suggestion in print settings (END).

The image processing apparatus 10 generates a change suggestion (step 205), and displays a suggestion button (step 206). Thus, the image processing apparatus 10 ends the process of generating a change suggestion in print settings (END).

### Concrete Examples

FIG. 6 is a diagram illustrating a concrete example of a setting screen displaying a suggestion button.

The image processing apparatus 10 displays, in a predetermined display area on a setting screen, a suggestion button for displaying a generated change suggestion of multiple print settings on a setting screen. In the example in FIG. 6, a suggestion button 201 is displayed in a tab list region in an upper portion of a setting screen including setting items, such as “The number of copies”, “Color mode”, and “Double-sided”. The suggestion button 201, which is displayed in the tab list region, blinks multiple times to draw a user's attention. When the user taps or clicks the suggestion button 201, a suggestion screen including a change suggestion in print settings is displayed.

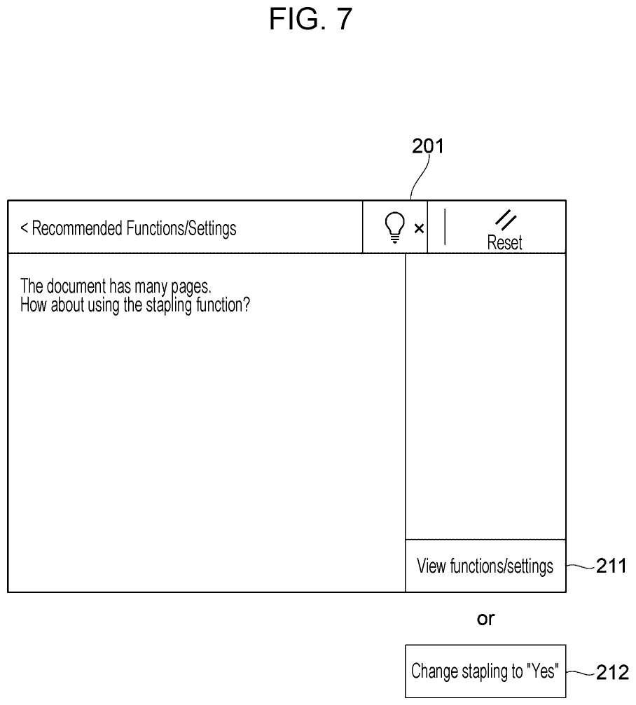

FIG. 7 is a diagram illustrating a concrete example of a suggestion screen displayed by pressing a suggestion button.

A suggestion screen displayed by pressing the suggestion button 201 includes a change suggestion in print settings. The suggestion screen in FIG. 7 displays, in addition to a label of “Recommended Functions/Settings”, text information, “The document has many pages. How about using the stapling function?” which describes a change suggestion in print settings.

The suggestion screen displays a setting change button. The suggestion screen in FIG. 7 displays a setting change button 211 labeled “View functions/settings”, or a setting change button 212 labeled “Change stapling to ‘Yes’”. When the setting change button 211 labeled “View functions/settings” among these is pressed, a screen, including the functions of the image processing apparatus 10 and the print settings, is displayed. In contrast, when the setting change button 212 labeled “Change stapling to ‘Yes’” is pressed, print settings are immediately changed according to the change suggestion in print settings.

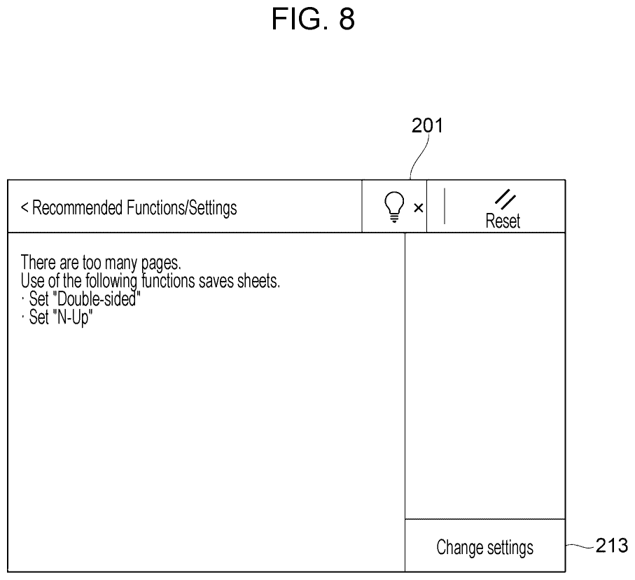

FIG. 8 is a diagram illustrating another concrete example of a setting change button displayed on a suggestion screen.

The suggestion screen in FIG. 8 displays, in addition to the label of “Recommended Functions/Settings”, text information, “There are too many pages. Use of the following functions saves sheets. ·Set ”Double-sided“ ·Set ‘N-Up’,” which describes a change suggestion in print settings. The change suggestion in print settings in FIG. 8 is displayed when the number of pages to be printed exceeds the predetermined value.

The suggestion screen in FIG. 8 displays a setting change button 213 labeled “Change settings”. When the setting change button 213 labeled “Change settings” is pressed, setting items suggested to be changed are displayed in a list.

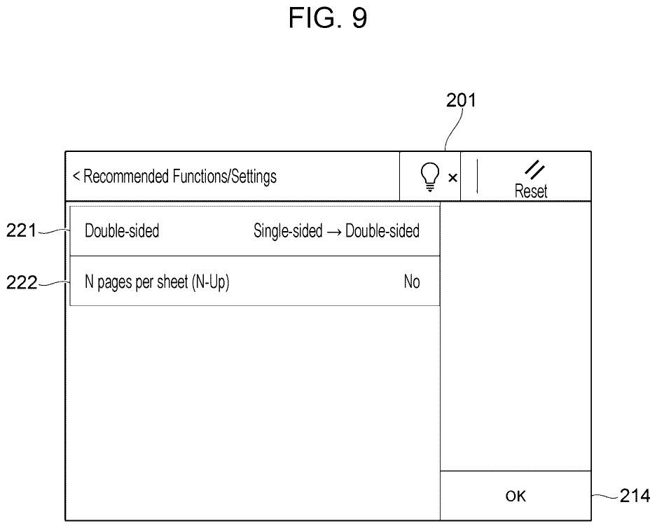

FIG. 9 is a diagram illustrating a concrete example of setting items which are suggested to be changed and which are displayed in a list by pressing a setting change button.

When the setting change button 213 in FIG. 8 is pressed, for example, as illustrated in FIG. 9, a setting item 221 labeled “Double-sided” and a setting item 222 labeled “N pages per sheet (N-Up)” are displayed in a list, as setting items suggested to be changed. When a user presses the setting item 221 labeled “Double-sided”, the “single-sided” printing, which is the current print setting, may be changed to “double-sided” printing.

When a user presses the setting item 222 labeled “N pages per sheet (N-Up)”, N-Up may be changed from “No”, which is the current print setting, to “Yes”. “N-Up” refers to printing N pages (N is an integer more than or equal to one) per sheet. When a user presses a button 214 labeled “OK”, the suggestion screen is closed.

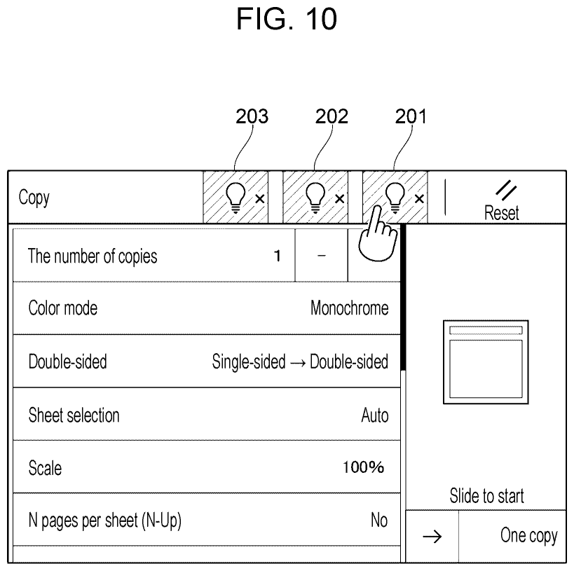

FIG. 10 is a diagram illustrating a concrete example of a setting screen displaying multiple suggestion buttons.

When multiple change suggestions in print settings are generated, the image processing apparatus 10 displays suggestion buttons, corresponding to the generated change suggestions in print settings, in the predetermined display area on the setting screen in a row. Specifically, the image processing apparatus 10 classifies the generated change suggestions in print settings into multiple types based on predetermined criteria, and displays, on the setting screen, the suggestion buttons corresponding to the respective types.

In the setting screen in FIG. 10, suggestion buttons 201 to 203 corresponding to three types are displayed in the tab list region in the upper portion of the setting screen including setting items, such as “The number of copies”, “Color mode”, and “Double-sided”. The suggestion buttons 201 to 203 displayed in the tab list region blink multiples types to draw a user's attention. When the user taps or clicks any of the suggestion buttons 201 to 203, a suggestion screen including the corresponding change suggestion in print settings is displayed.

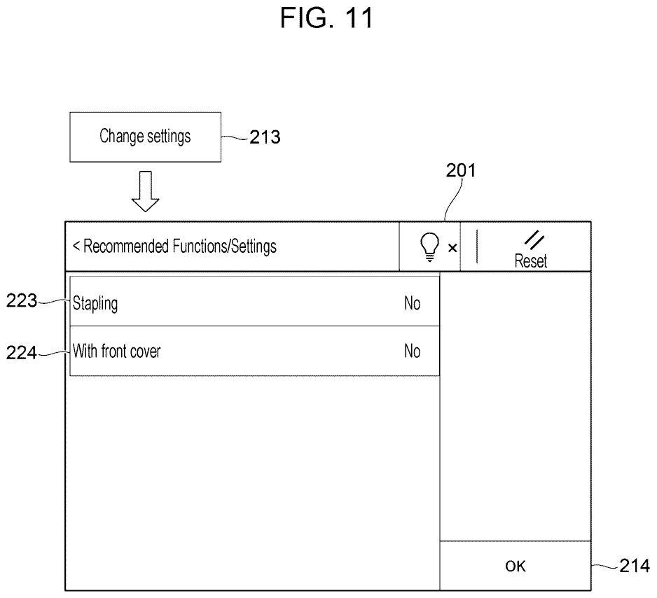

FIG. 11 is a diagram illustrating a concrete example of a suggestion screen in which a change suggestion of print settings of a type corresponding to the pressed suggestion button is displayed as a list.

Among the suggestion buttons 201 to 203 in FIG. 10, for example, assume that the suggestion button 201 is pressed, and that the setting change button 213 labeled “Change settings” is then pressed. In this case, a change suggestion of print settings of a type corresponding to the pressed suggestion button 201 is displayed as a list. In FIG. 11, a setting item 223 labeled “Stapling” and a setting item 224 labeled “With front cover” are displayed in a list as a change suggestion of print settings of the type corresponding to the suggestion button 201. In this case, the setting items 223 and 224 are setting items of a type classified in view of saving the number of sheets based on predetermined criteria.

### Other Exemplary Embodiments

The present exemplary embodiment is described above. However, the present disclosure is not limited to the exemplary embodiment described above. The effects of the present disclosure are not limited to those described in the exemplary embodiment. For example, the entire configuration of the image processing system 1, which is illustrated in FIG. 1, and the hardware configuration of the image processing apparatus 10, which is illustrated in FIG. 2, are merely examples for attaining the object of the present disclosure, and are not particularly limited.

The functional configuration of the image processing apparatus 10, which is illustrated in FIG. 3, is also merely an example, and is not particularly limited. Any configuration may be employed as long as a function for performing the above-described functions, as a whole, is provided for the image processing system 1 in FIG. 1. What functional configuration is used to implement the function is not limited to the example in FIG. 3. The order of steps in the processes of the image processing apparatus 10, which are illustrated in the flowcharts in FIGS. 4 and 5, is merely an example, and is not particularly limited. Other than processes performed in a time-series manner according to the order of illustrated steps, processes may be performed, not necessarily in a time series manner, but in parallel or individually. The concrete examples illustrated in FIGS. 6 to 11 are merely examples, and are not limited particularly.

The present disclosure may be applied also to programs and program products.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image processing apparatus comprising:
a processor configured to:
   generate a change suggestion in a print setting in accordance with a situation of the print setting; and
   display a button for displaying the generated change suggestion, on a setting screen for setting the print setting.
      (((2)))

The image processing apparatus according to (((1))),
wherein the processor is configured to:
   generate the change suggestion in accordance with the situation of the print setting and information of at least one of types of document information about a document to be printed, user information about a user who performs an operation on the setting screen, and printer information about the image processing apparatus which performs a print process.
      (((3)))

The image processing apparatus according to (((2))),
wherein the processor is configured to:
   generate the change suggestion in accordance with the situation of the print setting and a page count obtained from the document information.
      (((4)))

The image processing apparatus according to (((3))),
wherein the processor is configured to:
   when the page count exceeds a predetermined value, generate the change suggestion for suppressing a printed-sheet count.
      (((5)))

The image processing apparatus according to (((2))),
wherein the processor is configured to:
   generate the change suggestion in accordance with the situation of the print setting and information about the user's limitation on printing, the information about the user's limitation being obtained from the user information.
      (((6)))

The image processing apparatus according to (((5))),
wherein the processor is configured to:
   generate the change suggestion in accordance with the situation of the print setting and either one or both of types of the information about the user's limitation on printing, the types of the information being information about the user's limitation on a count of sheets usable in printing and information about the user's limitation on color usable in printing.
      (((7)))

The image processing apparatus according to (((2))),
wherein the processor is configured to:
   generate the change suggestion in accordance with the situation of the print setting and information about the image processing apparatus's limitation in printing, the information about the image processing apparatus's limitation being obtained from the printer information.
      (((8)))

The image processing apparatus according to (((7))),
wherein the processor is configured to:
   generate the change suggestion in accordance with the situation of the print setting and a remaining amount of material used in the print process, the remaining amount of material serving as the information about the image processing apparatus's limitation in printing.
      (((9)))

The image processing apparatus according to any one of (((1))) to (((8))),
wherein the processor is configured to:
   display a button for making the change, as well as the change suggestion.
      (((10)))

The image processing apparatus according to (((9))),
wherein the button for making the change is a button for displaying a setting screen for making the change.
   (((11)))

The image processing apparatus according to (((10))),
wherein the processor is configured to:
   in response to pressing the button for displaying a setting screen for making the change, display a setting item as a list, the setting item being suggested to be changed.
      (((12)))

The image processing apparatus according to (((9))),
wherein the button for making the change is a button for executing the change.
   (((13)))

The image processing apparatus according to any one of (((1))) to (((12))),
wherein the processor is configured to:
   display buttons in a predetermined display area of the setting screen, the buttons being for displaying a plurality of the generated change suggestions on setting screens.
      (((14)))

The image processing apparatus according to (((13))),
wherein the processor is configured to:
   when the plurality of the change suggestions are generated, display the buttons in the display area in a row, the buttons corresponding to the respective change suggestions.
      (((15)))

The image processing apparatus according to (((13))),
wherein the processor is configured to:
   classify the plurality of the change suggestions into a plurality of types on a basis of a predetermined criterion, and display, on the setting screen, the buttons corresponding to the respective types; and
   display, as a list, the change suggestion of the type corresponding to a pressed button.
      (((16)))

An image processing system comprising:
an image processing apparatus that performs a print process through a remote operation from an information processing terminal,
wherein the image processing apparatus includes the configuration of the image processing apparatus according to any one of (((1))) to (((15))).
   (((17)))

A program causing a computer to execute a process comprising:
generating a change suggestion in a print setting in accordance with a situation of the print setting; and
displaying a button for displaying the generated change suggestion, on a setting screen for setting the print setting.

What is claimed is:

1. An image processing apparatus comprising:
a processor configured to:
generate a change suggestion in a print setting in accordance with a situation of the print setting; and
display a button for displaying the generated change suggestion, on a setting screen for setting the print setting.

2. The image processing apparatus according to claim 1,
wherein the processor is configured to:
generate the change suggestion in accordance with the situation of the print setting and information of at least one of types of document information about a document to be printed, user information about a user who performs an operation on the setting screen, and printer information about the image processing apparatus which performs a print process.

3. The image processing apparatus according to claim 2,
wherein the processor is configured to:
generate the change suggestion in accordance with the situation of the print setting and a page count obtained from the document information.

4. The image processing apparatus according to claim 3,
wherein the processor is configured to:
when the page count exceeds a predetermined value, generate the change suggestion for suppressing a printed-sheet count.

5. The image processing apparatus according to claim 2,
wherein the processor is configured to:
generate the change suggestion in accordance with the situation of the print setting and information about the user's limitation on printing, the information about the user's limitation being obtained from the user information.

6. The image processing apparatus according to claim 5,
wherein the processor is configured to:
generate the change suggestion in accordance with the situation of the print setting and either one or both of types of the information about the user's limitation on printing, the types of the information being information about the user's limitation on a count of sheets usable in printing and information about the user's limitation on color usable in printing.

7. The image processing apparatus according to claim 2,
wherein the processor is configured to:
generate the change suggestion in accordance with the situation of the print setting and information about the image processing apparatus's limitation in printing, the information about the image processing apparatus's limitation being obtained from the printer information.

8. The image processing apparatus according to claim 7,
wherein the processor is configured to:
generate the change suggestion in accordance with the situation of the print setting and a remaining amount of material used in the print process, the remaining amount of material serving as the information about the image processing apparatus's limitation in printing.

9. The image processing apparatus according to claim 1,
wherein the processor is configured to:
display a button for making the change, as well as the change suggestion.

10. The image processing apparatus according to claim 9,
wherein the button for making the change is a button for displaying a setting screen for making the change.

11. The image processing apparatus according to claim 10,
wherein the processor is configured to:
in response to pressing the button for displaying a setting screen for making the change, display a setting item as a list, the setting item being suggested to be changed.

12. The image processing apparatus according to claim 9,
wherein the button for making the change is a button for executing the change.

13. The image processing apparatus according to claim 1,
wherein the processor is configured to:
display buttons in a predetermined display area of the setting screen, the buttons being for displaying a plurality of the generated change suggestions on setting screens.

14. The image processing apparatus according to claim 13,
wherein the processor is configured to:
when the plurality of the change suggestions are generated, display the buttons in the display area in a row, the buttons corresponding to the respective change suggestions.

15. The image processing apparatus according to claim 13,
wherein the processor is configured to:
classify the plurality of the change suggestions into a plurality of types on a basis of a predetermined criterion, and display, on the setting screen, the buttons corresponding to the respective types; and
display, as a list, the change suggestion of the type corresponding to a pressed button.

16. An image processing system comprising:
an image processing apparatus that performs a print process through a remote operation from an information processing terminal,
wherein the image processing apparatus includes the configuration of the image processing apparatus according to claim 1.

17. An image processing system comprising:
an image processing apparatus that performs a print process through a remote operation from an information processing terminal,
wherein the image processing apparatus includes the configuration of the image processing apparatus according to claim 2.

18. An image processing system comprising:
an image processing apparatus that performs a print process through a remote operation from an information processing terminal,
wherein the image processing apparatus includes the configuration of the image processing apparatus according to claim 3.

19. A non-transitory computer readable medium storing a program causing a computer to execute a process comprising:
generating a change suggestion in a print setting in accordance with a situation of the print setting; and
displaying a button for displaying the generated change suggestion, on a setting screen for setting the print setting.

20. A method comprising:
generating a change suggestion in a print setting in accordance with a situation of the print setting; and
displaying a button for displaying the generated change suggestion, on a setting screen for setting the print setting.
